(19) United States
(12) Patent Application Publication
(10) Pub. No.: US 2016/0090069 A1
(43) Pub. Date: Mar. 31, 2016

(54) CONTROL METHOD AND APPARATUS OF ELECTRONIC PARKING BRAKE

(71) Applicant: HYUNDAI MOBIS CO., LTD., Seoul (KR)

(72) Inventor: Jae Woo JEON, Seongnam-si (KR)

(21) Appl. No.: 14/699,927

(22) Filed: Apr. 29, 2015

(30) Foreign Application Priority Data
Sep. 25, 2014 (KR) 10-2014-0128308

(51) Int. Cl. B60T 8/172; B60T 1/00

(52) U.S. Cl. CPC B60T 8/172; B60T 1/005

(57) ABSTRACT

A control method and apparatus of an electronic parking brake is disclosed. In an embodiment, a control method of an electronic parking brake comprises, determining by a control part whether a braking power transfer generation condition is satisfied, the braking power transfer generation condition being a condition that a braking power by a main brake is transferred to a braking power by a parking brake; determining whether a braking power transfer to the braking power by the parking brake is generated if the braking power transfer generation condition is satisfied; counting a lapsed time after the braking power transfer is generated if it is determined that the braking power transfer is generated; and generating an additional braking power to the parking brake according to the counted lapsed time.

### CROSS-REFERENCE TO RELATED APPLICATION

The present application claims priority under 35 U.S.C. §119(a) to Korean patent application number 10-2014-0128308, filed on Sep. 25, 2014, in the Korean Intellectual Property Office, which is incorporated herein by reference in its entirety.

### BACKGROUND

1. Technical Field

Embodiments relate to a control method and apparatus of an electronic parking brake, and more particularly, to a control method and apparatus of an electronic parking brake to compensate a decrease of a braking power generated in the process that a braking power is transferred from the braking power by a main brake to the braking power by a parking brake in braking a vehicle.

2. Related Art

In a vehicle in which an electronic parking brake (EPB) is installed, when an operation condition of the EPB is satisfied by the request of a driver, an EPB ECU which controls the EPB drives an EPB motor and a target clamping force by the EPB is generated, and therefore a vehicle is maintained to be stopped.

The background technology is disclosed in Korean Laid-open Patent Publication No. 10-2014-0031682 (published on Mar. 13, 2014, title of invention: control method of an electronic parking brake system).

### SUMMARY

Various embodiments are directed to a control method and apparatus of an electronic parking brake which is devised. An aspect of the invention provides a control method and apparatus of an electronic parking brake to compensate a decrease of the braking power of a parking brake generated in the braking power transfer process that a braking power is transferred from the braking power by the main brake to the braking power of the parking brake in braking a vehicle.

Another aspect of the invention provides a control method and apparatus of an electronic parking brake wherein a load sensor for monitoring a braking power of a parking brake for the compensation of the decrease of a braking power of a parking brake is not used and wherein an additional braking power is generated to compensate a braking power of a parking brake by counting the elapsed time after the elimination of a braking power of a brake when the transfer of a braking power is generated.

In an embodiment, a control method of an electronic parking brake comprising: determining by a control part whether a braking power transfer generation condition is satisfied, the braking power transfer generation condition being a condition that a braking power by a main brake is transferred to a braking power by a parking brake; determining whether a braking power transfer from the braking power by the main brake to the braking power by the parking brake is generated if the braking power transfer generation condition is satisfied; counting a lapsed time after the braking power transfer is generated if it is determined that the braking power transfer is generated; and generating an additional braking power to the parking brake according to the counted lapsed time.

In an embodiment, in determining whether a braking power transfer generation condition is satisfied, wherein the control part determines that the braking power transfer generation condition is satisfied if a vehicle is stopped after the main brake is operated and if an operation of the main brake is released after the parking brake is operated.

In an embodiment, in determining whether a braking power transfer generation condition is satisfied, wherein the control part sets a braking power transfer preparation flag if the vehicle is stopped after the main brake is operated and if the parking brake is operated.

In an embodiment, in generating an additional braking power to the parking brake according to the counted lapsed time, wherein the control part generates the additional braking power if the lapsed time passes a predetermined reference time.

In an embodiment, in generating an additional braking power to the parking brake according to the counted lapsed time, wherein the control part generates the additional braking power if the lapsed time passes a reference time which is determined variably according to a vehicle behavior status.

In an embodiment, the control part determines the vehicle behavior status based on at least one of a vehicle speed, a wheel speed and a vehicle acceleration.

In an embodiment, a control apparatus of an electronic parking brake comprising: a main brake status sensing part to sense an operation of a main brake; a vehicle behavior status sensing part to sense a behavior status of a vehicle; a parking brake driving part to drive a parking brake; and a control part, wherein the control part determines whether a braking power transfer generation condition is satisfied based on the result of sensing of the main brake status sensing part and the vehicle behavior status sensing part, the braking power transfer generation condition being a condition that a braking power by a main brake is transferred to a braking power by a parking brake, determines whether a braking power transfer from the braking power by the main brake to the braking power by the parking brake is generated if the braking power transfer generation condition is satisfied, counts a lapsed time after a generation of the braking power transfer if it is determined that the braking power transfer is generated, generates an additional braking power to the parking brake according to the counted lapsed time by the parking brake driving part.

In an embodiment, the control part determines that the braking power transfer generation condition is satisfied if a vehicle is stopped after the main brake is operated and if an operation of the main brake is released after the parking brake is operated.

In an embodiment, in determining whether the braking power transfer generation condition is satisfied, wherein the control part sets a braking power transfer preparation flag if the vehicle is stopped after the main brake is operated and if the parking brake is operated.

In an embodiment, the control part generates the additional braking power if the counted lapsed time passes a predetermined reference time.

In an embodiment, the control part generates the additional braking power if the counted lapsed time passes a reference time which is determined variably according to a vehicle behavior status.

In an embodiment, the control part determines the vehicle behavior status based on at least one of a vehicle speed, a wheel speed, and a vehicle acceleration.

In an embodiment, a control method and apparatus of an electronic parking brake compensates a decrease of the braking power of a parking brake generated in the process that a braking power is transferred from the braking power by the main brake to the braking power of the parking brake in braking a vehicle, lowers the level of a braking power required in the operation of a parking brake, and therefore may enhance the durability of the components and may secure the necessary braking power.

In an embodiment, an additional braking power is generated by counting the lapsed time after the braking power of the main brake is eliminated when the transfer of the braking power is generated, and therefore a load sensor which has been used to compensate the decrease of the braking power of the parking brake and a circuitry for the load sensor are not needed, and the costs can be saved.

### BRIEF DESCRIPTION OF THE DRAWINGS

FIG. 1 is a block diagram showing a control device of an electronic parking brake according to an embodiment.

FIG. 2 is a flow chart showing the flow of the control method of an electronic parking brake according to an embodiment.

### DETAILED DESCRIPTION

Hereinafter, embodiments will be described below with reference to the accompanying drawings through various examples.

While various embodiments have been described below, it will be understood to those skilled in the art that the embodiments described are by way of example only. Accordingly, the device or equipment described herein should not be limited based on the described embodiments.

An EPB comprises an electric actuator which can be controlled electronically, a torque (load) converter such as a decelerator or a screw, and an operation part which operates to a parking brake and generates a braking power. In an EPB utilizing a drum brake including a drum in hat (DIH) as a foundation of a parking brake, a braking power for operating a parking brake decreases due to the characteristics of a drum brake in the process of transferring a braking power that a braking power by a main brake, which is generated by stepping on a brake pedal, is transferred to a braking power by a parking brake. Accordingly, an operation efficiency decreases, the required intensity of a parking brake system increases, and a durability performance decreases.

To avoid or minimize the decrease of a braking power which is generated in an EPB wherein a drum brake is used as a parking brake foundation, a load sensor is used to monitor a braking power and to compensate a braking power immediately when a braking power decreases. However, a load sensor is relatively expensive and the use of the load sensor incurs the increase of costs.

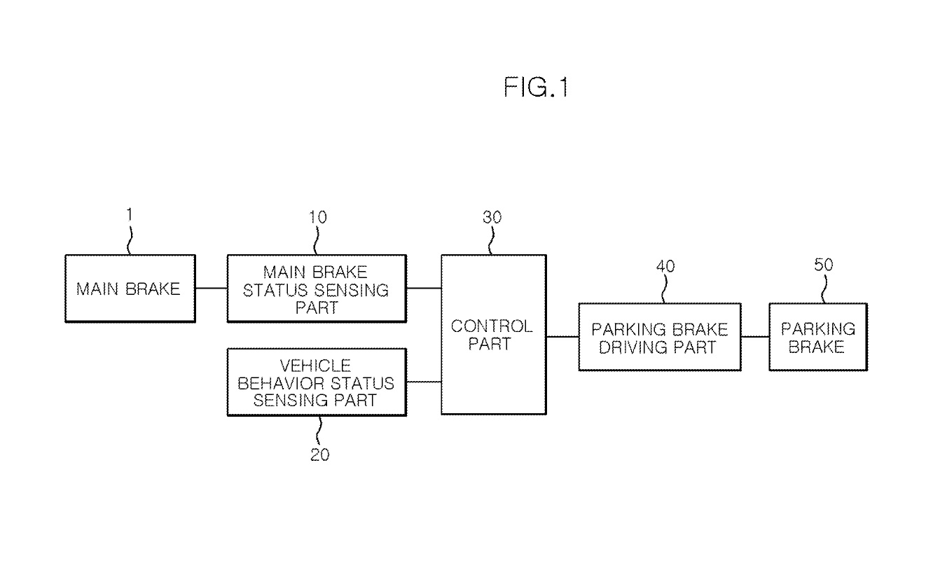

FIG. 1 is a block diagram showing a control device of an electronic parking brake according to an embodiment.

A control device of an electronic parking brake according to an embodiment in FIG. 1 includes a main brake status sensing part 10, a vehicle behavior status sensing part 20, a control part 30 and a parking brake driving part 40.

A control apparatus of an electronic parking brake according to an embodiment is to compensate a decrease of a braking power in an EPB in which a drum brake, including a drum in hat (DIH), is used as a parking brake 50.

A main brake status sensing part 10 receives the operational information and others of a brake pedal, a master cylinder pressure, and an ESC (electronic stability control) and senses the operation of the main brake 1.

A vehicle behavior status sensing part 20 receives a vehicle speed, a wheel speed, an acceleration and others and senses the motion of a vehicle.

A control part 30 determines whether or not a braking power transfer generation condition that a braking power by a main brake 1 is transferred to a braking power by a parking brake 50 is satisfied. If a braking power transfer generation condition is satisfied, the control part determines whether or not a braking power transfer to a parking brake 50 is generated, counts a lapsed time after the transfer is generated, controls a parking brake driving part 40 according to the counted lapsed time, and generates an additional braking power to a parking brake 50.

Hereinafter, the definition of a braking power transfer is that a braking power by a main brake 1 equipment wherein a pedal of a main brake 1 is operated by a driver in braking a vehicle and a braking power is generated to whole wheels by an oil pressure is transferred to a braking power by a parking brake 50 equipment wherein a braking power is generated to two rear wheels like a drum brake, including a drum in hat (DIH).

The following steps are accomplished for the control part 30 to determine whether or not a braking power transfer condition is satisfied wherein a braking power by a main brake 1 is transferred to a braking power by a parking brake 50.

If the operation of a main brake 1 is sensed according to a main brake status sensing part 10, it is sensed whether or not a vehicle is stopped by a vehicle behavior status sensing part 20. If it is sensed that a vehicle is stopped, a braking power transfer preparation flag is set based the operation of a parking brake 50. If a parking brake 50 is not operated, a braking power transfer preparation flag is not set. If a parking brake 50 is operated, a braking power transfer preparation flag is set. Thereafter, if the operation of the main brake 1 is released (that is, the braking power of a main brake is eliminated), it is determined that the braking power transfer generation condition is satisfied.

The control part 30 determines whether or not the braking power transfer is generated to the braking power by a parking brake 50 according to the setting status of a braking power transfer preparation flag. If it is determined that a braking power transfer is generated, the lapsed time after the generation of the transfer is counted.

The transfer timing is determined as a timing when the operation of a main brake 1 is released after a parking brake 50 is operated, and a lapsed time after the transfer timing is counted. The count method of a lapsed time may be one which can recognize the flow of time, such as the use of an increase of count, a decrease of count, or the use of a separate time task.

The control part 30 controls a parking brake driving part 40 according to the counted lapsed time and generates an additional braking power to a parking brake 50.

In detail, an additional braking power is generated if a counted lapsed time passes a predetermined reference time (that is, a fixed set value), or if it passes a reference time which is determined variably according to a vehicle behavior status inputted from a vehicle behavior status sensing part 20 (that is, a value determined variably by reflecting the status of a vehicle).

An additional braking power may be a predetermined value or a variable value adjusted according to a vehicle status.

As described above, a control apparatus of an electronic parking brake according to an embodiment compensates a decrease of the braking power of a parking brake generated in the process that a braking power is transferred from the braking power by the main brake to the braking power of the parking brake in braking a vehicle, lowers the level of a braking power required in the operation of a parking brake, and therefore may enhance the durability of the components and may secure the necessary braking power.

In addition, an additional braking power is generated by counting the lapsed time after the elimination of the braking power of the brake when the transfer of the braking power is generated, and therefore a load sensor which has been used to compensate the decrease of the braking power of the parking brake and a circuitry for the load sensor are not needed, and the costs can be saved.

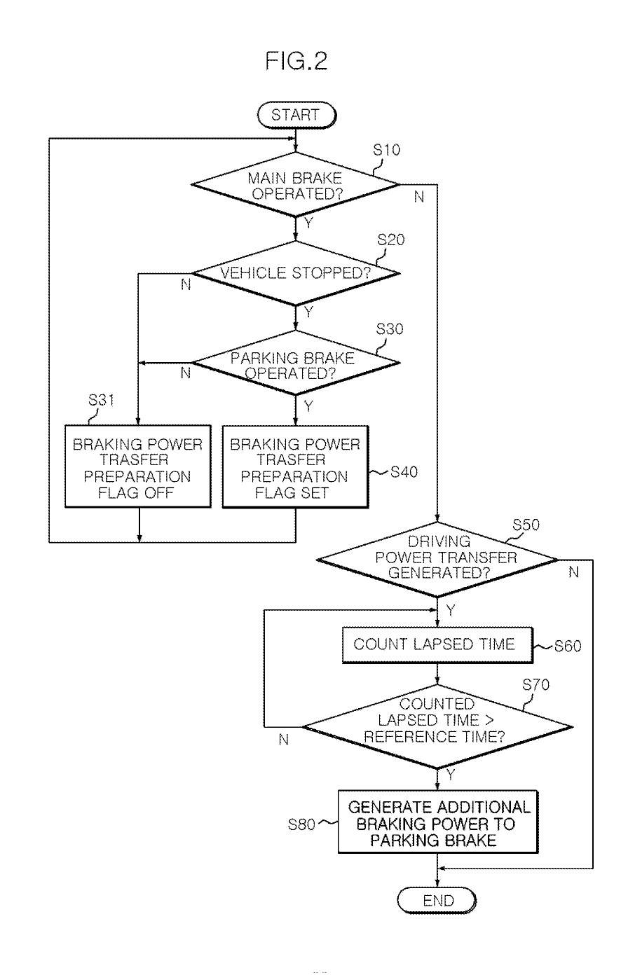

FIG. 2 is a flow chart showing the operation flow of the control method of an electronic parking brake according to an embodiment. A detailed operation is explained referring to FIG. 2.

An embodiment relates to a control method to compensate a decrease of a braking power in an EPB wherein a drum brake including a drum in hat (DIH), in which a decrease of a brake power is generated, is used as a parking brake 50. The detailed operations are as follows.

The following steps are accomplished for the control part 30 to determine whether or not a braking power transfer generation condition is satisfied wherein a braking power by a main brake 1 is transferred to a braking power by a parking brake 50.

Hereinafter, the definition of the transfer of a braking power is that a braking power by a main brake 1 equipment, wherein a pedal of a main brake 1 is operated by a driver in braking a vehicle and a braking power is generated to whole wheels by an oil pressure, is transferred to a braking power by a parking brake 50 equipment wherein a braking power is generated to two rear wheels like a drum brake, including a drum in hat (DIH).

If an operation of a main brake 1 is sensed according to a main brake status sensing part 10 (S10), a control part 30 senses whether or not a vehicle is stopped according to a vehicle behavior status sensing port 20 (S20). If it is sensed that a vehicle is stopped, a control part 30 sets a parking power transfer preparation flag as to whether or not a parking brake 50 is operated (S30). If a parking brake 50 is not operated, a braking power transfer preparation flag is not set (S31). If a parking brake 50 is operated, a braking power transfer preparation flag is set (S40). If the operation of a main brake 1 is released (that is, the braking power of a main brake is eliminated), a control part 30 determines that a braking power transfer generation condition is satisfied.

A main brake status sensing part 10 receives the operation information of a brake pedal, a master cylinder pressure, an electronic stability control (ESC) and others and senses the operation of a main brake 1. A vehicle behavior status sensing part 20 receives a vehicle speed, a wheel speed, an acceleration information and others and senses the motion of a vehicle.

Thereafter, if a braking power transfer generation condition is satisfied, a control part 30 determines whether or not a braking power transfer to a parking brake 50 is generated (S50). If a vehicle is not stopped in step S20, or if a parking brake 50 is not operated in step S30, or if a braking power transfer preparation flag is not set in step S31, it is determined that a braking power transfer is not generated.

However, if the operation of a main brake 1 is released after a braking power transfer preparation flag is set in step S40, a control part 30 determines that a braking power transfer is generated to a braking power by a parking brake 50, and counts a lapsed time after the transfer is generated (S60).

The transfer timing is determined as a timing when the operation of a main brake 1 is released after a parking brake 50 is operated, and a lapsed time after the transfer timing is counted. The count method of a lapsed time may be one which can recognize the flow of time, such as the use of an increase of count, a decrease of count, or the use of a separate time task.

The control part 30 controls a parking brake driving part 40 according to the counted lapsed time and generates an additional braking power to a parking brake 50 (S70, S80).

In detail, an additional braking power may be generated if a counted lapsed time passes a predetermined reference time (that is, a fixed set value), or if it passes a reference time which is determined variably according to a vehicle behavior status inputted from a vehicle behavior status sensing part 20 (that is, a value determined variably by reflecting the status of a vehicle).

An additional braking power may be a predetermined value or a variable value adjusted according to a vehicle status.

As described above, a control method of an electronic parking brake according to an embodiment compensates a decrease of the braking power of a parking brake generated in the process that a braking power is transferred from the braking power by the main brake to the braking power of the parking brake in braking a vehicle, lowers the level of a braking power required in the operation of a parking brake, and therefore may enhance the durability of the components and may secure the necessary braking power.

In addition, an additional braking power is generated by counting the lapsed time after the elimination of the braking power of the brake when the transfer of the braking power is generated, and therefore a load sensor which has been used to compensate the decrease of the braking power of the parking brake and a circuitry for the load sensor are not needed, and the costs can be saved.

While various embodiments have been described above, it will be understood to those skilled in the art that the embodiments described are by way of example only. Accordingly, the device or the method described herein should not be limited based on the described embodiments.

What is claimed is:

1. A control method of an electronic parking brake comprising:
determining by a control part whether a braking power transfer generation condition is satisfied, the braking power transfer generation condition being a condition that a braking power by a main brake is transferred to a braking power by a parking brake;
determining whether a braking power transfer from the braking power by the main brake to the braking power by the parking brake is generated if the braking power transfer generation condition is satisfied;
counting a lapsed time after the braking power transfer is generated if it is determined that the braking power transfer is generated; and
generating an additional braking power to the parking brake according to the counted lapsed time.

2. The method of claim 1, in determining whether a braking power transfer generation condition is satisfied, wherein the control part determines that the braking power transfer generation condition is satisfied if a vehicle is stopped after the main brake is operated and if an operation of the main brake is released after the parking brake is operated.

3. The method of claim 2, in determining whether a braking power transfer generation condition is satisfied, wherein the control part sets a braking power transfer preparation flag if the vehicle is stopped after the main brake is operated and if the parking brake is operated.

4. The method of claim 1, in generating an additional braking power to the parking brake according to the counted lapsed time, wherein the control part generates the additional braking power if the lapsed time passes a predetermined reference time.

5. The method of claim 1, in generating an additional braking power to the parking brake according to the counted lapsed time, wherein the control part generates the additional braking power if the lapsed time passes a reference time which is determined variably according to a vehicle behavior status.

6. The method of claim 5, wherein the control part determines the vehicle behavior status based on at least one of a vehicle speed, a wheel speed and a vehicle acceleration.

7. A control apparatus of an electronic parking brake comprising:
a main brake status sensing part to sense an operation of a main brake;
a vehicle behavior status sensing part to sense a behavior status of a vehicle;
a parking brake driving part to drive a parking brake; and
a control part,
wherein the control part determines whether a braking power transfer generation condition is satisfied based on the result of sensing of the main brake status sensing part and the vehicle behavior status sensing part, the braking power transfer generation condition being a condition that a braking power by a main brake is transferred to a braking power by a parking brake, determines whether a braking power transfer from the braking power by the main brake to the braking power by the parking brake is generated if the braking power transfer generation condition is satisfied, counts a lapsed time after a generation of the braking power transfer if it is determined that the braking power transfer is generated, and generates an additional braking power to the parking brake according to the counted lapsed time by the parking brake driving part.

8. The apparatus of claim 7, wherein the control part determines that the braking power transfer generation condition is satisfied if a vehicle is stopped after the main brake is operated and if an operation of the main brake is released after the parking brake is operated.

9. The apparatus of claim 8, in determining whether a braking power transfer generation condition is satisfied, wherein the control part sets a braking power transfer preparation flag if the vehicle is stopped after the main brake is operated and if the parking brake is operated.

10. The apparatus of claim 7, wherein the control part generates the additional braking power if the counted lapsed time passes a predetermined reference time.

11. The apparatus of claim 7, wherein the control part generates the additional braking power if the counted lapsed time passes a reference time which is determined variably according to a vehicle behavior status.

12. The method of claim 11, wherein the control part determines the vehicle behavior status based on at least one of a vehicle speed, a wheel speed and a vehicle acceleration.
